(19) United States
(12) Patent Application Publication
(10) Pub. No.: US 2022/0232093 A1
(43) Pub. Date: Jul. 21, 2022

(54) Method of Automated Registration

(71) Applicant: Ilya Vladimirovich REDKOKASHIN, g. Rostov-na-Donu (RU)

(72) Inventor: Ilya Vladimirovich REDKOKASHIN, g. Rostov-na-Donu (RU)

(21) Appl. No.: 17/294,402

(22) PCT Filed: Sep. 6, 2019
(86) PCT No.: PCT/RU2019/000628

§ 371 Date: May 15, 2021

(30) Foreign Application Priority Data
Nov. 15, 2018 (RU) 2018140424

(51) Int. Cl. H04L 67/306; G06F 21/62; G06F 21/32

(52) U.S. Cl. CPC H04L 67/306; G06Q 50/01; G06F 21/32; G06F 21/6245

(57) ABSTRACT

The invention refers to field of computer networks, in particular to the methods of registration. More specifically the invention refers to the methods of users registration with the using of biometric data.

The method of automized registration including in itself receiving from user information which necessary in further to login of user in creating account and/or biometric data of user using registration points, or personal computers with ability to read biometric data, after that by using server, the contact information of the user is automatically created and registered the user by server, while not providing contact information for the user , and contact information is tied to the biometric data of the user, so that the user can transmitting contact information to other users for communication while using of biometric data.

Proposed invention provides users registration, with providing increased confidential of created while registration contact information.

### TECHNICAL FIELD

The invention refers to field of computer networks, in particular to the methods of registration. More specifically the invention refers to the methods of users registration with the using of biometric data.

### PRECEDING LEVEL OF TECHNOLOGY

Nowadays to create registration data using information which was gaven from the user, such as for example login or password, which user using in further for login in to his own account. In this case identifiers assigned to the users. Those identifiers users use to exchange for communication between each other. Immediately after registration the user is informed his identifier.

Written above method is convenient for common users registration, but it is not suitable for registering users who want to control their contact information, cause for control the contact information it is necessary, that it will be hidden, and to transmitting it, a resource is required that only the user possesses.

The task set by the developer of method of automized registration, consist in development of method which compared to analogies will allow to registering users, providing increased confidentiality created during registration contact information.

Technical result of declared method of automized registration, is users registration which provides increased confidentiality created during registration contact information.

### DISCLOSURE OF INVENTION

The essence of method of automized registration, consist in that, that by computers with ability to read biometric data from user, receiving information which is necessary in further to user's log in created account, and/or biometric user's data, or by the registration points, further by using server automatically creating registration details and contact information of user, while didn't give contact information for user, but linking contact information for biometric data of user, that user can transmit contact information by using biometric data for other users communication. Registration can be made for e-mail and as contact information using the name of e-mail. Also registration can be made for messenger or social network, while contact information can be user page, or nickname, or login, or mobile phone number. Login in the account can be made by the help of biometric data.

### EXAMPLE OF A SPECIFIC APPLICATION OF THE INVENTION

Declared method of automized registration, it can be also named as method of creating registration data or method of security providing and contact information controlling, consist in next. For realization of declared method server requesting from user biometric data and information which necessary for registration, such as created by user login, password, full name and other data. Can be asking only biometric data, but other data, such as login and password automatically generating and provided to the user further, in case if user need them.

User with the help of electronic device such as for example cellphone, tablet, computer and so on, and Internet transmits requested information to the server. Also necessary data for users registration can be received on registration points, such as registration points of mobile telecommunications operator, where workers entering all data in computer which transmitting data to the server.

After getting of necessary data by one of aforementioned methods, the server automatically registering user and linking biometrical data to the contact information, thus, that the user in further can transmit contact information by biometric data providing. Wherein the contact information hidden from everybody, including the user too.

For better understanding, what such registration gives, let's show what will happen after registration, described in the invention. For transmitting contact information to other users, registered user will provide biometric data, to which contact information is linked, while the contact information will be hidden. This mean that during contact information transmitting, the user transfers on personal device of other users his own biometric data and later this devices received hidden contact information which allow to contact with user, who gave biometric data. Contact information on all devices will be hidden and externally will be look like an icon, while pressing on which will occur connect with the user. When transmitting contact information, for checking, also can be requesting another automatically generated information, such as for example user's geolocation.

For aforementioned transmitting contact information method, most of all fits described in invention method of automatically registration, Such registration can be provided for messengers, e-mail services, social networks, mobile operators and any other services which creating user's contact information.

Biometric data also can be used for logging in of user in to account. Then it matters with what purpose user transmitting his biometric data. If on his own device is going biometric data transmitting, then occurs logging in account, if on stranger, then transmitting of contact information.

1. The method of automized registration in which at first by using registration points or personal computers with ability to read biometric data from user, receive information from a user which necessary to user's login in account that will be created, and biometric user's data or receive biometric data from a user, after that by using server, the contact information of the user is automatically created and registered user, while not providing contact information for the user, and contact information is tied to the biometric data of the user, so that the user can transmitting contact information to other users for communication while using of biometric data.

2. The method of automized registration based on claim 1, wherein that registration is made for e-mail and as contact information using the name of e-mail.

3. The method of automized registration based on claim 1, wherein, that the registration is made for messengers or social network service and as contact information using the user's page or nickname, or login, or phone number.

4. The method of automized registration based on claim 1, wherein in addition, that login in the account provided by the help of biometric data.

5. The method of automized registration based on claim 1, wherein, that registration is made in system of mobile operator, and the contact information is the mobile phone number.
